(19) United States
(12) Patent Application Publication
(10) Pub. No.: US 2010/0209166 A1
(43) Pub. Date: Aug. 19, 2010

(54) Recording device, recording method, and program

(75) Inventors: Yukiko Kanekiyo, Tokyo (JP); Taro Suito, Kanagawa (JP); Kuriko Takeshima, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/658,270

(22) Filed: Feb. 9, 2010

(30) Foreign Application Priority Data
Feb. 19, 2009 (JP) P2009-036714

(51) Int. Cl. B41J 11/44

(52) U.S. Cl. 400/76

(57) ABSTRACT

A recording device that duplicates contents recorded in a first recording medium on a detachable second recording medium includes: selection means for selecting duplication subject contents to be duplicated on the second recording medium among the contents recorded in the first recording medium; duplicating means for duplicating the selected duplication subject contents on the second recording medium; generation means for generating label surface information that indicates contents recorded in the second recording medium after the duplication subject contents are duplicated thereon and is to be printed on a label surface of the second recording medium; and print control means for causing the generated label surface information to be printed on the label surface of the second recording medium.

### BACKGROUND OF THE INVENTION

1. Field of the Invention

The present invention relates to a recording device, a recording method, and a program, and more particularly, to a recording device, a recording method, and a program configured not only to duplicate, for example, contents, such as a TV program, recorded in a first recording medium on a disc medium as a second recording medium but also to make print on the label surface of the disc medium.

2. Description of the Related Art

Many types of exiting video recorder include a hard disc drive (hereinafter, abbreviated to HDD) and a disc drive in and from which a disc medium can be loaded and unloaded. The term, “disc medium”, referred to herein means recordable DVD (Digital Versatile Disc) and BD (Blu-Ray Disc).

The video recorder is configured in such a manner that the built-in HDD or a disc medium loaded into the disc drive can be selected as the recording destination of contents, such as a recorded TV program, and meta data thereof.

Also, the video recorder has a capability of duplicating contents and meta data saved in the HDD on a disc medium or conversely duplicating contents saved in a disc medium on the HDD. It should be noted that the term, “duplicate” or “duplication”, referred to herein means operations to copy and move the contents.

Incidentally, in a case where contents on the HDD are duplicated on a disc medium, the user has to go through tedious procedures of selecting contents the user wishes to duplicate (duplication subjects) except for a case where all the contents on the HDD are collectively duplicated on a disc medium.

In order to lessen such burden on the user, for example, JP-A-2008-77735 proposes an invention of selecting contents corresponding to a series of TV programs among contents on the HDD as the duplication subjects on the ground that the preprogram IDs for timer recording are the same.

### SUMMARY OF THE INVENTION

According to the invention disclosed in JP-A-2008-77735, however, it is quite difficult to select duplication subjects in various manners, for example, selecting contents including appearances of the same actor collectively as the duplication subjects or selecting contents in the same category as the duplication subjects.

In addition, in a case where duplication is made by additionally recording contents into a disc medium having already recorded some other contents, a technique such that enables selection of contents to be duplicated (additionally recorded) on the basis of existing contents on the disc medium has not been established.

In the related art, there is a method of displaying a list of recorded contents when a disc medium is loaded into the video recorder so that the user can understand contents recorded in the disc medium. The simplest method is to write information of the recorded contents on the label surface of a disc medium.

It is, however, quite tedious for the user to write such information regardless of whether he manually writes the information on the label surface of a disc medium or makes print using a printer.

Thus, it is desirable to provide a technique of duplicating contents saved in a first recording medium on a second recording medium by collectively carrying out jobs of selecting contents as the duplication subjects, duplicating, and making print on the label surface of the second recording medium.

According to an embodiment of the present invention, there is provided a recording device that duplicates contents recorded in a first recording medium on a detachable second recording medium including selection means for selecting duplication subject contents to be duplicated on the second recording medium among the contents recorded in the first recording medium, duplicating means for duplicating the selected duplication subject contents on the second recording medium, generation means for generating label surface information that indicates contents recorded in the second recording medium after the duplication subject contents are duplicated thereon and is to be printed on a label surface of the second recording medium, and print control means for causing the generated label surface information to be printed on the label surface of the second recording medium.

It may be configured in such a manner that the selection means selects contents relevant to contents already recorded in the second recording medium among the contents recorded in the first recording medium as the duplication subject contents to be duplicated on the second recording medium.

It may be configured in such a manner that the recording device further includes obtaining means for obtaining the label surface information recorded in the second recording medium and that the generation means updates the label surface information correspondingly to a state where the duplication subject contents are duplicated on the second recording medium and the print control means causes additional print to be made on the label surface of the second recording medium on the basis of the updated label surface information.

It may be configured in such a manner that the selection means presents to a user candidates of a duplication subject to be duplicated on the second recording medium among the contents recorded in the first recording medium and selects contents selected among the candidates of the duplication subject by the user as the duplication subject contents.

It may be configured in such a manner that the recording device further includes print means for making print on the label surface of the second recording medium and that the print control means controls the control means to print the generated label surface information on the label surface of the second recording medium.

According to another embodiment of the present invention, there is provided a recording method of a recording device that duplicates contents recorded in a first recording medium on a detachable second recording medium including the steps, by the recording device, of: selecting duplication subject contents to be duplicated on the second recording medium among the contents recorded in the first recording medium; duplicating the selected duplication subject contents on the second recording medium; generating label surface information that indicates contents recorded in the second recording medium after the duplication subject contents are duplicated thereon and is to be printed on a label surface of the second recording medium; and causing the generated label surface information to be printed on the label surface of the second recording medium.

According to still another embodiment of the present invention, there is provided a control program of a recording device that duplicates contents recorded in a first recording medium on a detachable second recording medium causing a computer in the recording device to perform processing including the steps of: selecting duplication subject contents to be duplicated on the second recording medium among the contents recorded in the first recording medium; duplicating the selected duplication subject contents on the second recording medium; generating label surface information that indicates contents recorded in the second recording medium after the duplication subject contents are duplicated thereon and is to be printed on a label surface of the second recording medium; and causing the generated label surface information to be printed on the label surface of the second recording medium.

According to the embodiments of the present invention, the duplication subject contents to be duplicated on the second recording medium are selected among the contents recorded in the first recording medium and the selected duplication subject contents are duplicated on the second recording medium. Also, the label surface information that indicates the contents recorded in the second recording medium after the duplication subject contents are duplicated thereon and is to be printed on the label surface of the second recording medium is generated. The generated label surface information is printed on the label surface of the second recording medium.

According to the embodiments of the present invention, when the contents saved in the first recording medium are duplicated on the second recording medium, it becomes possible to collectively carry out jobs of selecting contents as the duplication subjects, duplicating, and making print on the label surface of the second recording medium.

### BRIEF DESCRIPTION OF THE DRAWINGS

FIG. 1 is a view showing an example of the configuration of a system including a video recorder to which an embodiment of the present invention is applied;

FIG. 2 is a block diagram showing an example of the configuration of the video recorder to which an embodiment of the present invention is applied;

FIG. 3 is a block diagram showing an example of the detailed configuration of a control portion of FIG. 2;

FIG. 4 is a flowchart used to describe duplicating and printing processing;

FIG. 5 is a flowchart used to describe duplication candidate presentation processing;

FIG. 6 is a view showing a display example of a UI screen when a disc medium is loaded;

FIG. 7 is a view showing a display example of a UI screen presenting duplication subject candidates in a case where the disc medium is a blank disc;

FIG. 8 is a view showing a display example of a UI screen presenting duplication subject candidates in a case where the disc medium is not a blank disc;

FIG. 9 is a view showing a display example of a simplified UI screen presenting duplication subject candidates in a case where the disc medium is not a blank disc;

FIG. 10 is a view showing a display example of a duplication subject selection screen;

FIG. 11 is a view showing a display example when presenting a print original form of the label surface;

FIG. 12 is a view showing another display example when presenting a print original form of the label surface;

FIG. 13 is a view showing another display example of the duplication subjects selection screen;

FIG. 14 is a view showing still another display example of the duplication subjects selection screen; and

FIG. 15 is a view showing still another display example of the duplication subjects selection screen.

### DESCRIPTION OF THE PREFERRED EMBODIMENT

Hereinafter, an embodiment of the present invention will be described in detail with reference to the drawings.

### Example of Configuration of System

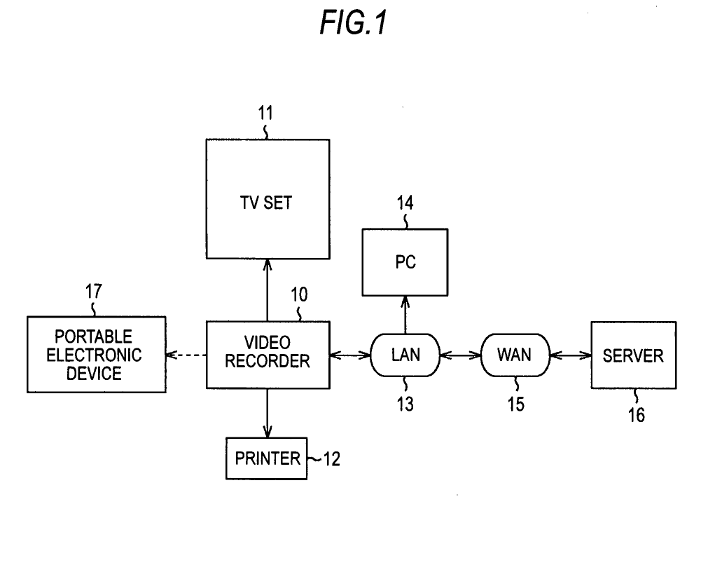

FIG. 1 shows an example of the configuration of a system including a video recorder 10 as an embodiment of the present invention.

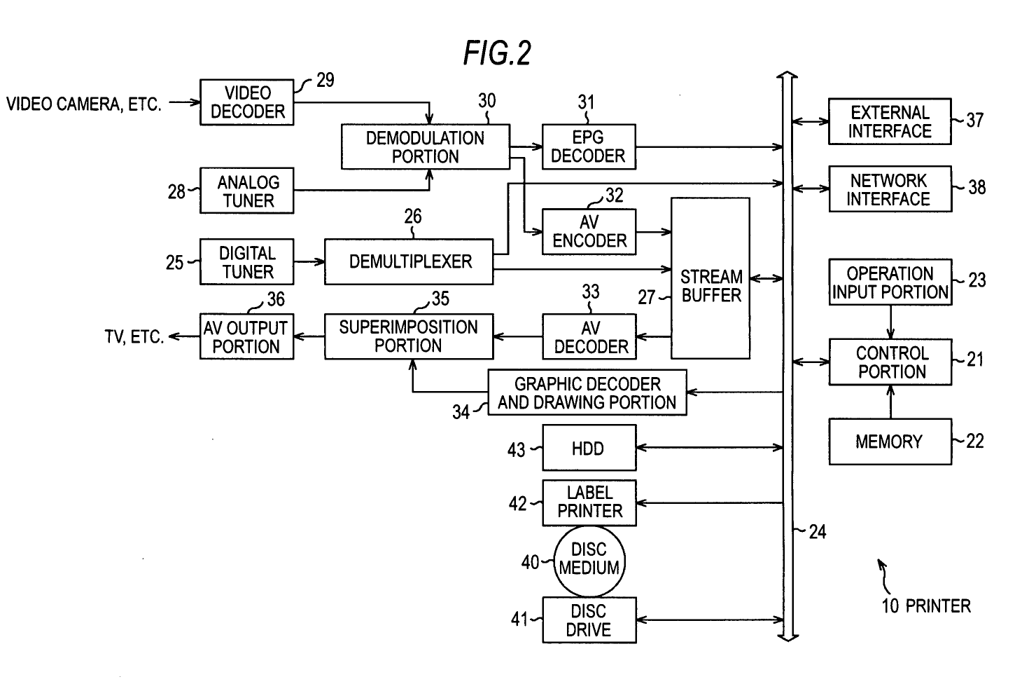

The video recorder 10 records contents, chiefly represented by TV programs, and outputs a video and a sound of the contents to a monitor, such as a TV set 11, by reproducing the recorded contents. Also, when contents recorded in a built-in HDD 43 are duplicated on a disc medium 40 loaded in a disc drive 41 (all of which are shown in FIG. 2), the video recorder 10 collectively carries out jobs of selecting contents as duplication subjects, duplicating, and making print on the label surface of the disc medium 40.

The video recorder 10 has an internal label printer (FIG. 2) that makes print on the label surface of the disc medium 40. It is, however, also possible to make print on the label surface of the disc medium 40 using an external printer 12. In this case, it goes without saying that the user has to move the disc medium 40 from the video recorder 10 to the printer 12.

In addition, the video recorder 10 can be connected to a PC 14 via a LAN 13. Further, the video recorder 10 can be connected to a predetermined server 16 via the LAN 13 and a WAN 15. Furthermore, the video recorder 10 can be connected to a portable electronic device 17, such as a mobile phone, a PDA (Personal Digital Assistance), and a PSP® (Play Station Portable), using a predetermined radio communication standard (such as Bluetooth).

### Example of Configuration of Video Recorder 10

FIG. 2 is a block diagram showing an example of the configuration of the video recorder 10.

The video recorder 10 includes a control portion 21 that controls respective portions of the video recorder 10, a memory 22 that holds a control program run by the control portion 21, an operation input portion 23 formed of a remote controller or the like that accepts operations of the user, and a bus 24 that serves as a transmission path of control information and various types of data from the control portion 21. Illustrations of control lines from the control portion 21 to the respective portions via the bus 24 are omitted for ease of illustration.

The video recorder 10 further includes a digital tuner 25, a demultiplexer 26, a stream buffer 27, an analog tuner 28, a video recorder 29, a demodulation portion 30, an EPG (Electronic Program Guide) decoder 31, and an AV encoder 32.

The digital tuner 25 receives a digital broadcast signal, such as terrestrial digital broadcasts and BS digital broadcasts, and outputs the received digital broadcast signal to the demultiplexer 26. The demultiplexer 26 isolates the digital broadcast signal inputted therein from the digital tuner 25 into AV data and EPG data and outputs the AV data to the stream buffer 27 and the EPG data to the HDD 43 or the like via the bus 24.

The analog tuner 28 receives an analog broadcast signal and outputs the received analog broadcast signal to the demodulation portion 30. The video decoder 29 decodes a digital AV signal inputted therein from a video camera or a USB memory connected to an external interface 37 and outputs the resulting analog AV signal to the demodulation portion 30. The demodulation portion 30 demodulates the analog broadcast signal and outputs the resulting analog AV signal to the AV encoder 32 and the resulting EPG data in an encoded form to the EPG decoder 31. The EPG decoder 31 decodes the EPG data in an encoded form and supplies the decoded EPG data to the HDD 43 or the like via the bus 24.

The AV encoder 32 encodes the analog AV signal inputted therein by a predetermined coding method (MEPG2 or the like) and supplies the resulting encoded AV data to the stream buffer 27.

Moreover, the video recorder 10 includes an AV decoder 33, a graphic decoder and drawing portion 34, a superimposition portion 35, an AV output portion 36, an external interface 37, and a network interface 38.

The AV decoder 33 decodes the AV data inputted therein from the stream buffer 27 and outputs the resulting audio signal and video signal to the superimposition portion 35. The graphic decoder and drawing portion 34 generates drawing bit map data for various setting screens and UI screens and decodes still image data (JPEG images or the like) to output the resulting image signal to the superimposition portion 35. The superimposition portion 35 properly superimposes the image signal supplied from the graphic decoder and drawing portion 34 on the video signal from the decoder 33 and outputs the resulting superimposed signal to the AV output portion 36. The AV output portion 36 outputs the audio signal and the video signal to the TV set 11 in the latter stage.

The external interface 37 is formed, for example, of a USB terminal, an i.LINK terminal, or a Bluetooth module, and connected to the printer 12, a digital video camera, and a USB memory to enable communications of various types of data and control commands. The network interface 38 is connected to the LAN 13 and the WAN 15 by wired and wireless connections.

Further, the video recorder 10 includes a disc drive 41, a label printer 42, and an HDD 43.

The disc drive 41 writes contents and meta data thereof supplied therein via the bus 24 into a disc medium 40 loaded therein.

The disc medium 40 referred to herein means a disc-like recording medium, such as a DVD and a BD, of a write-once type having a printable label surface.

Also, the disc drive 41 reads out contents and meta data thereof recorded in the disc medium 40 and outputs the read contents and meta data to the decoder 33 via the bus 24. It may be configured in such a manner that the disc drive 41 includes an internal disc changer so that a plurality of disc media 40 can be loaded therein.

The label printer 42 prints label surface information made up of titles of contents recorded in the disc medium 40 on the label surface of the disc medium 40 while it is loaded in the disc drive 41.

This configuration enables the video recorder 10 to record contents into the recording layer of the disc medium 40 and to make print on the label surface continuously while the disc medium 40 is loaded in the disc drive 41.

It should be appreciated, however, that printing on the label surface of the disc medium 40 may be performed by the printer 12 connected to the video recorder 10 via the external interface 37 or the network interface 38 without using the label printer 42.

The HDD 43 records therein AV data originating from a digital broadcast signal, AV data obtained by encoding an analog broadcast signal, and AV data originating from an externally inputted AV signal. Hereinafter, the AV data recorded in the HDD 43 is referred to also as the contents. Also, the HDD 43 records meta data correlated with the recorded contents. As the meta data corresponding to the contents, the EPG data obtained from a broadcast signal and program information obtained from the predetermined server on the Internet as well as information inputted by the user and characteristic information extracted from a video or a sound can be adopted.

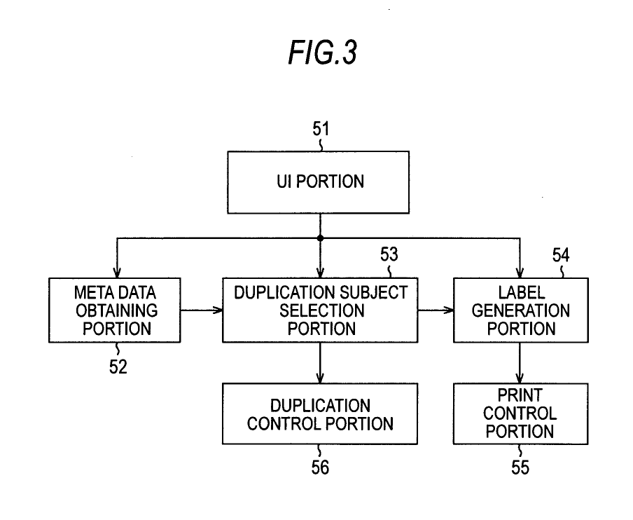

FIG. 3 shows an example of the configuration of functional blocks achieved when the control portion 21 runs a control program recorded in the memory 22. It should be appreciated, however, that the respective functional blocks shown in FIG. 3 may be formed of hardware.

A UI portion 51 generates a video signal of various setting screens and various UI screens presented to the user and controls a display of these screens. The UI portion 51, monitors an input from the user relating to various setting screens and UI screens. A meta data obtaining portion 52 obtains meta data corresponding to recorded contents from the HDD 43 or the disc medium 40 and outputs the meta data to a duplication subject selection portion 53.

The duplication subject selection portion 53 selects contents (hereinafter, referred to as the duplication subject contents) to be duplicated on the disc medium 40 from the HDD 43 on the basis of operations by the user and the meta data inputted therein from the meta data obtaining portion 52.

A label generation portion 54 generates label surface information (that is, a print original form of the label surface) to be printed on the label surface of the disc medium 40 after the duplication subject contents are recorded therein on the basis of a label surface printing template prepared in advance and the meta data of the contents to be duplicated. In a case where contents have been already recorded in the disc medium 40, new label surface information (print original form of the label surface) is generated on the basis of the label surface information recorded in the disc medium 40 as the data.

A print control portion 55 controls the label printer 42 to print the generated label surface information (print original form of the label surface) on the label surface of the disc medium 40.

A duplication control portion 56 controls the HDD 43 and the disc drive 41 to duplicate the duplication subject contents recorded in the HDD 43 on the disc medium 40. The duplication control portion 56 records the generated label surface information into the disc medium 40.

### Description of Operation

An operation of the video recorder 10 will now be described.

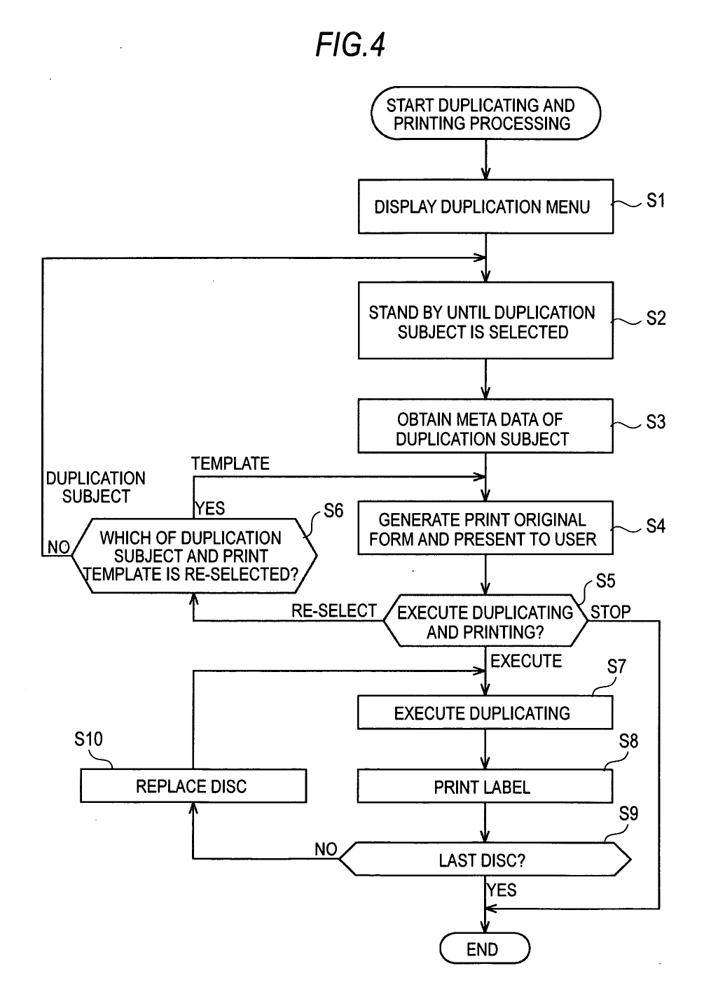

FIG. 4 is a flowchart used to describe duplicating and printing processing by the video recorder 10.

The duplicating and printing processing is to duplicate the duplication subject contents selected by the user onto the disc medium 40 and to make print on the label surface of the disc medium 40 after duplication.

The duplicating and printing processing is started when the user specifies a display of the duplication menu (UI screen).

In Step S1, the UI portion 51 generates and displays a duplication list formed of a list of contents with duplication authorization among the contents recorded in the HDD 43. In Step S2, the UI portion 51 stands by until the user selects one or more duplication subject contents on the duplication list screen being displayed. When the user selects the duplication subject contents, the duplication subject selection portion 53 determines the duplication subject contents according to the selection of the user and notifies the label generation portion 54 and the duplication control portion 56 of the determination result.

In Step S3, the label generation portion 54 obtains the meta data of the duplication subject contents from the HDD 43. In Step S4, the label generation portion 54 generates the label surface information by applying the meta data obtained in Step S2 to the label printing template prepared in advance and outputs the label surface information to the UI portion 51 and the print control portion 55. The UI portion 51 displays the label surface information (print original form of the label surface) on the screen, that is, displays and presents a print preview to the user.

In Step S5, the UI portion 51 stands by until the user who has viewed the presented print preview specifies an execution or a stop of duplicating and printing, a re-selection of the duplication subject, or a re-selection of the label printing template.

In Step S5, in a case where a re-selection is specified, the flow proceeds to the processing in Step S6. In Step S6, the UI portion 51 determines whether a re-selection of the duplication subject or a re-selection of the label printing template is specified. In a case where a re-selection of the duplication subject is specified, the flow returns to the processing in Step S2 and the duplication subject contents are re-selected.

In a case where a re-selection of the label printing template is specified, the flow returns to Step S4 and the label surface information is generated again using another label printing template.

In Step S5, in a case where an execution of duplicating and printing is specified, the flow proceeds to the processing in Step S7.

In Step S7, the duplication control portion 56 controls the HDD 43 and the disc drive 41 to duplicate the duplication subject contents notified in Step S2 on the loaded disc medium 40.

It should be noted, however, that there is a case where all the duplication subject contents are not recorded on the single disc medium 40 because of the number and the data size of the duplication subject contents and an available capacity of the disc medium 40. In such a case, one or more duplication subject contents may be divided and duplicated on a plurality of disc media 40. In a case where contents are divided and duplicated on a plurality of disc media 40, it is configured in such a manner that the flow proceeds to the processing in Step S8 when recording in a currently loaded disc medium 40 ends.

In Step S8, the printing control portion 55 controls the label printer 42 to print the label surface information (print original form of the label surface) notified in Step S4 on the label surface of the disc medium 40. The duplication control portion 56 controls the disc drive 41 to record the label surface information after the printing on the label surface into the disc medium 40.

In Step S9, in a case where one or more duplication subject contents are divided and duplicated on a plurality of disc media 40, the duplication control portion 56 determines whether the currently loaded disc medium 40 is the last disc. When it is determined that the currently loaded disc medium 40 is not the last disc, the flow proceeds to the processing in Step S10. In Step S10, the UI portion 51 requests the user to replace the disc medium 40 with another one. When the disc medium 40 is replaced with another one, the flow returns to the processing in Step S7 to repeat the processing thereafter.

In a case where a stop of duplicating and printing is specified in Step S5, the duplicating and printing processing is ended at this point.

As has been described, according to the duplicating and printing processing, not only is it possible to duplicate one or more duplication subject contents selected by the user on one or more disc medium 40, but it is also possible to print the label surface information on the label surface of the disc medium 40.

In the duplicating and printing processing described above, it may be configured in such a manner that a re-selection of the label printing template is inhibited by preparing only one type of label printing template. In this case, the processing in Step S6 is omitted and when a re-selection is specified in Step S5, the flow returns to the processing in Step S2.

Also, the processing in Step S9 and S10 may be omitted by configuring in such a manner so as to duplicate as much contents as can be duplicated on the single disc medium without concerning a case where one or more duplication subject contents are divided and duplicated on a plurality of disc media 40.

Further, in a case where the disc drive 41 has an internal disc changer, replacement of the disc media 40 performed manually by the user in the description above can be automated.

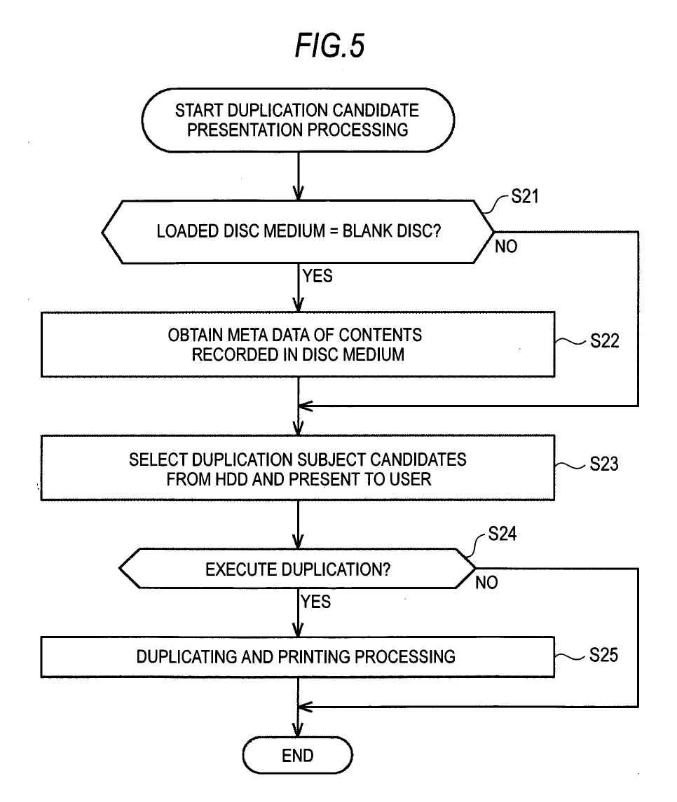

FIG. 5 is a flowchart used to describe duplication candidate presentation processing by the video recorder 10.

The duplication candidate presentation processing is to select duplication subject contents candidates from the contents with duplication authorization among those recorded in the HDD 43 and to present the candidates to the user.

The duplication candidate presentation processing is started in response to a predetermined instruction from the user when the disc medium 40 is loaded into the disc drive 41.

In Step S21, the duplication subject selection portion 53 determines whether the currently loaded disc medium 40 is a black disc in which no contents have been recorded on the basis of the information from the disc drive 41. In a case where it is determined that the disc medium 40 is not a blank disc, the flow proceeds to the processing in Step S22. In a case where it is determined that the disc medium 40 is a blank disc, Step S22 is skipped.

In Step S22, the duplication subject selection portion 53 controls the disc drive 41 to obtain the meta data of the contents recorded in the disc medium 40, the available capacity (remaining capacity) of the disc medium 40, and the label surface information of the disc medium 40.

In Step S23, the duplication subject selection portion 53 obtains the meta data of the contents with duplication authorization among those recorded in the HDD 43 and selects the duplication subject contents candidates on the basis of the obtained meta data. Herein, assume that the meta data contains the title of the contents, the performers, the explanation on the contents, the broadcast channel, and the broadcast date.

To be more concrete, in a case where the currently loaded disc medium 40 is a blank disc, the contents with duplication authorization in the HDD 43 are grouped by mutual relevance and the contents are selected as the duplication subject contents candidates. For example, in a case where a plurality of contents of a program broadcasted by so-called simultaneous broadcasting are recorded, the contents having the highest image quality or the contents having the longest program description are selected as the duplication subject candidate.

Also, in a case where the currently loaded disc medium 40 is not a blank disc, of the contents with duplication authorization in the HDD 43, the contents relevant to the contents already recorded in the disc medium 40 are selected as the duplication subject contents candidates.

The term, “relevant contents”, referred to herein means the contents of different episodes of the same program, the contents belonging to the same category, the contents including appearances of the same performer, the contents handling the same material, and so forth. More concrete examples will be described below with reference to display examples of the screen.

Further, in Step S23, the duplication subject selection portion 53 notifies the UI portion 51 of the selected duplication subject contents candidates. In response to this notification, the UI portion 51 displays a list of the duplication subject candidates on the screen to present the list to the user. It may be configured in such a manner that the label surface information (print original form of the label surface) of the disc medium 40 is generated and presented to the user together with the list. In a case where the disc medium 40 is not a blank disc, the label surface information obtained in Step S22 is referred to when the label surface information is generated.

In Step S24, the UI portion 51 stands by until the user having viewed the presented list of the duplication subject candidates specifies either an execution or a stop of duplication.

In a case where an execution of duplication is specified in Step S24, the flow proceeds to the processing in Step S25. In Step S25, after the user specifies the duplication subject contents among the presented duplication subject candidates, the processing in Step S2 and thereafter in the duplicating and printing processing described above with reference to FIG. 4 is carried out.

In a case where an execution of duplication is not specified and a stop of duplication is specified in Step S24, the duplication candidate presentation processing is ended. The description of the duplication candidate presentation processing now ends.

### Display Example of Screen

The UI screens during the duplicating and printing processing and the duplication candidate presentation processing described above will now be described.

The UI screens described below are generally superimposed on a video of a TV program received at the video recorder 10 or a video of the reproduced contents and displayed on the TV set 11 used as a monitor. It is, however, possible to display the UI screens, for example, on the screen of the remote controller, the screen of the PC 14 connected to the video recorder 10 via the LAN 13, or on the screen of the electronic device 17 wirelessly connected to the video recorder 10.

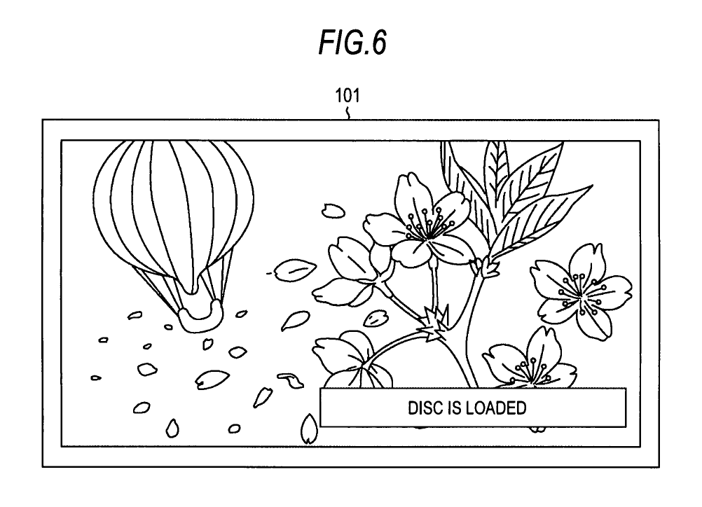

FIG. 6 is a display example of the UI screen pop-up displayed when the disc medium 40 is loaded into the disc drive 41. A UI screen 101 enables the user to recognize that the disc medium 40 is loaded properly into the disc drive 41.

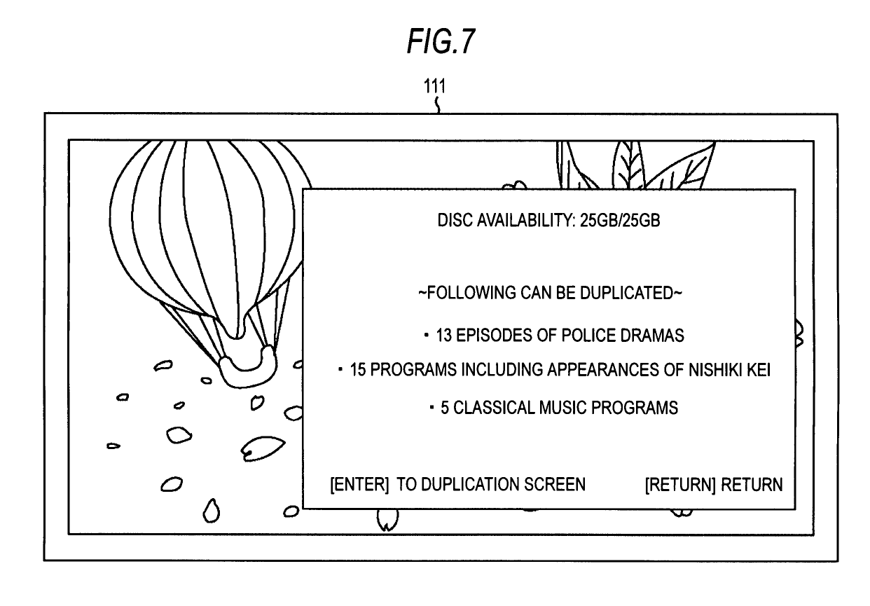

FIG. 7 is a display example of a UI screen 111 presenting the duplication subject candidates in a case where the loaded disc medium 40 is a blank disc. The UI screen 111 shows that groups of contents belonging to the same categories (police drama and classical music program) and a group of contents including appearances of the same performer can be duplicated. The UI screen 111 enables the user to understand that the loaded disc medium 40 is a blank disc as well as the groups of the duplication subject candidates.

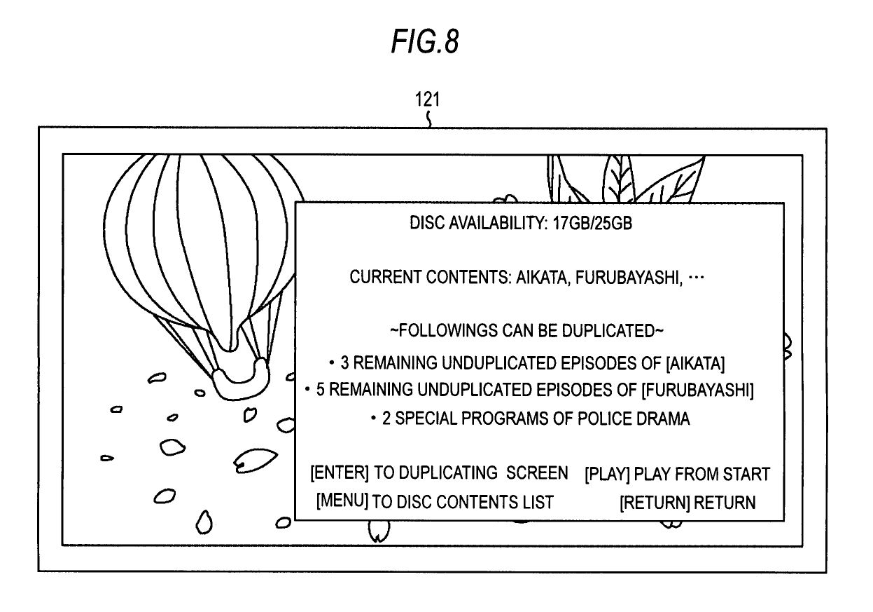

FIG. 8 is a display example of a UI screen 121 presenting the duplication subject candidates in a case where the loaded disc medium 40 is not a blank disc. The UI screen 121 enables the user not only to understand the contents recorded in the loaded disc medium 40 but also to understand the duplication subject candidates relevant to the recorded contents.

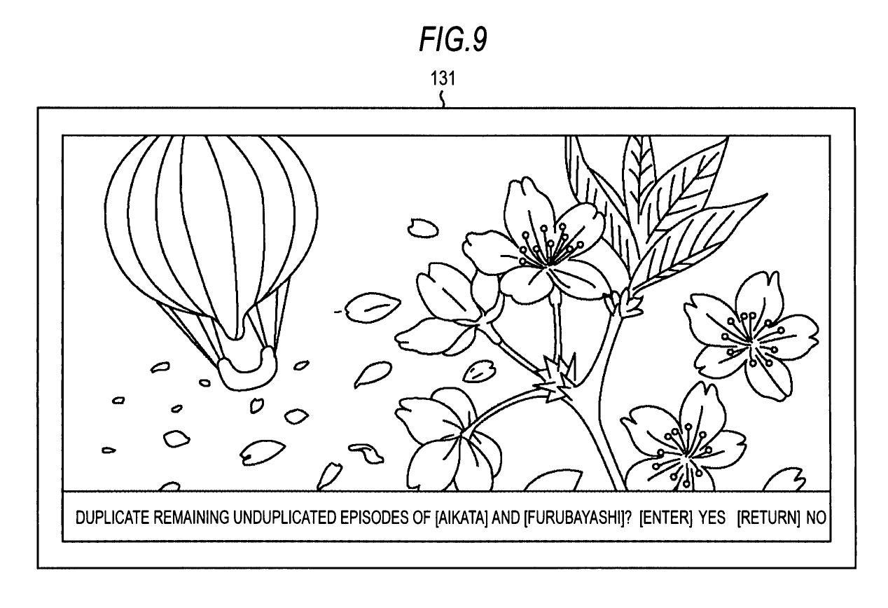

FIG. 9 is a display example of a simplified UI screen 131 presenting the duplication subject candidates in a case where the loaded disc medium 40 is not a blank disc. This display not only enables the user to understand the contents recorded in the loaded disc medium 40 but also easily instructs the user about the duplication of the duplication subject candidates relevant to the recorded contents.

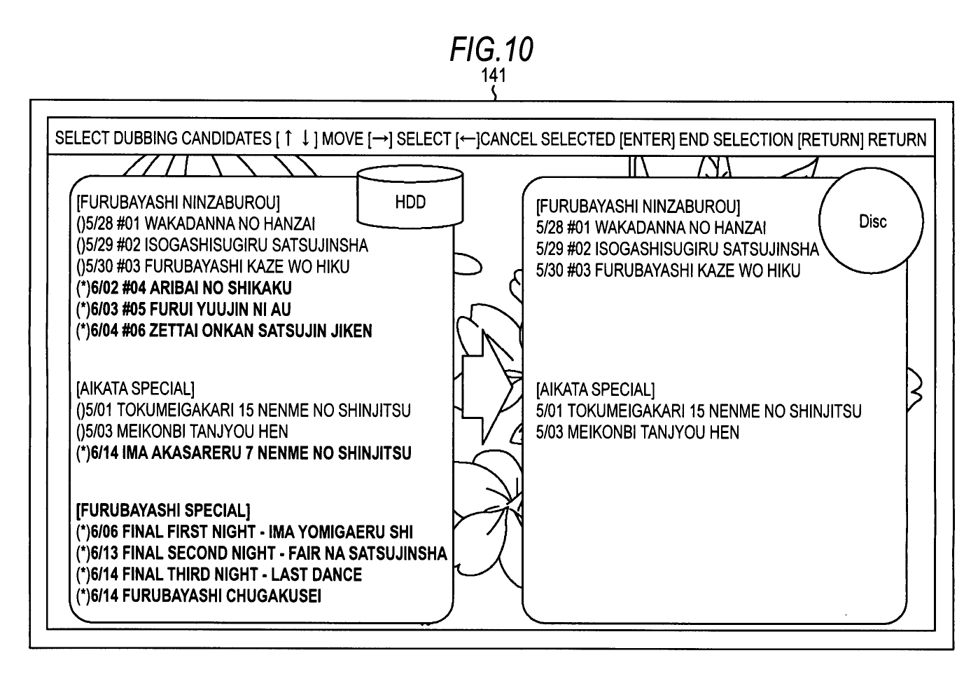

FIG. 10 is a display example of a duplication subject selection screen transitioned from the UI screen 121 shown in FIG. 8. A duplication subject selection screen 141 shows the titles of the contents recorded in the HDD 43 group by group. Also, the duplication subject selection screen 141 shows the titles of the contents recorded in the disc medium 40 group by group.

Further, of the contents recorded in the HDD 43, the contents as the duplication subject candidates are highlighted in comparison with the contents other than the duplication subject candidates. In FIG. 10, for ease of illustration, the titles of the duplication subject contents are shown in the Arial Narrow-Bold font and the titles of the contents other than the duplication subjects are shown in the Arial Narrow font. It should be appreciated, however, that the highlighting method is not limited to the above method and, for example, the color or the size of characters may be changed.

Further, of the duplication subject candidates, marks are put on those selected as the duplication subjects by the user. In the example of FIG. 10, all of the duplication subject candidates are selected as the duplication subjects and asterisks (*) are put next to the titles. It may be configured in such a manner that the contents selected as the duplication subjects by the user are additionally displayed in the title display (the right side of FIG. 10) of the contents recorded in the disc medium 40. Further, it may be configured in such a manner that a total data volume of the contents selected as the duplication subjects and a remaining capacity of the disc medium 40 after duplication are also displayed.

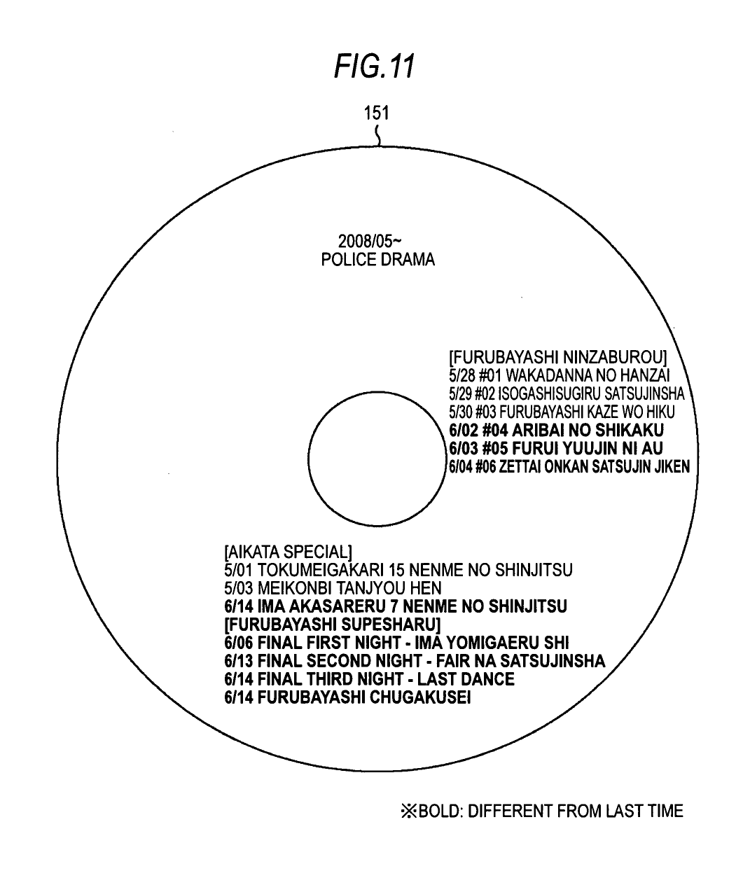

FIG. 11 shows a display example of a print original form 151 of the label surface presented to the user after the duplication subjects are selected. As is shown in the drawing, in the stage of the print original form 151 of the label surface, information of the contents to be printed in addition to the information of the contents recorded in the disc medium 40 is shown in highlight. In FIG. 11, for ease of illustration, information of the duplication subject contents is shown in the Arial NarrowBold font and information of the recorded contents is shown in the Arial Narrow font. It should be appreciated, however, that the highlighting method is not limited to this method.

Also, for ease of description, FIG. 11 shows a presentation example of the original form in which an additional print portion is highlighted. It may be configured in such a manner that an actual print result (that is, an original form in which all are shown in the Arial Narrow font) in which the information is not differentially highlighted is presented to the user as the necessity arises. Further, it may be configured in such a manner that a highlighted state and a non-highlighted state can be switched from each other.

On the label surface are printed the date (for example, 2008/05˜) when the writing is made first in the recording medium 40, information (for example, POLICE DRAMA) indicating the relevance of the contents recorded in the disc medium 40, the titles of the contents (for example, FURUBAYASHI NINZABUROU and AIKATA SPECIAL), broadcast dates and sub-titles of contents (for example, 5/28 #01 WAKADANNA NO HANZAI).

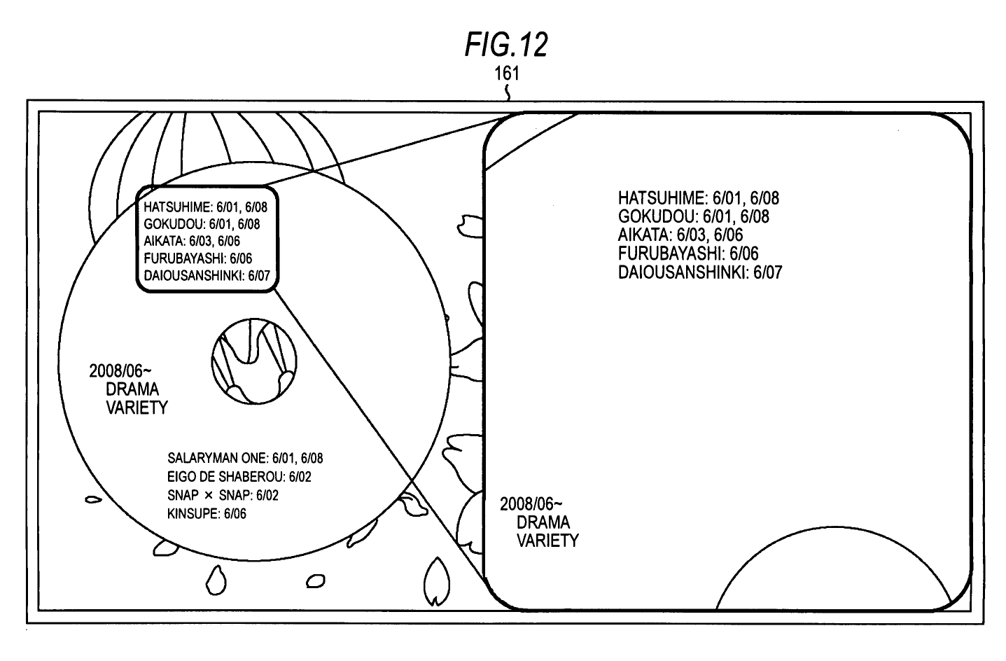

FIG. 12 shows a display example of a UI screen 161 showing a print original form of the label surface presented to the user after the duplication subjects are selected. As is shown in the drawing, it may be configured in such a manner that the user specifies an arbitrary point on the label surface so that the specified point is displayed in an enlarged scale. When an enlarged display is available as above, the user can readily confirm the information to be printed in a case where many characters are to be written on the label surface.

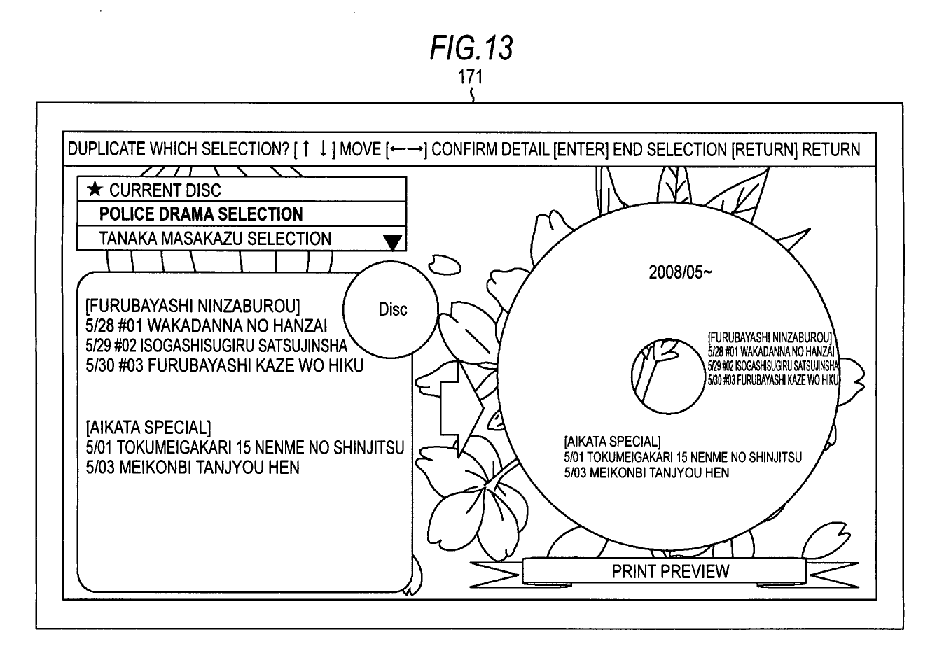

FIG. 13 is another display example of the UI screen displayed when the disc medium 40 is loaded into the disc drive 41 as with the example of FIG. 6. A duplication subject selection screen 171 shows information of the contents recorded in the disc medium 40 and a current print state of the label surface of the disc medium 40.

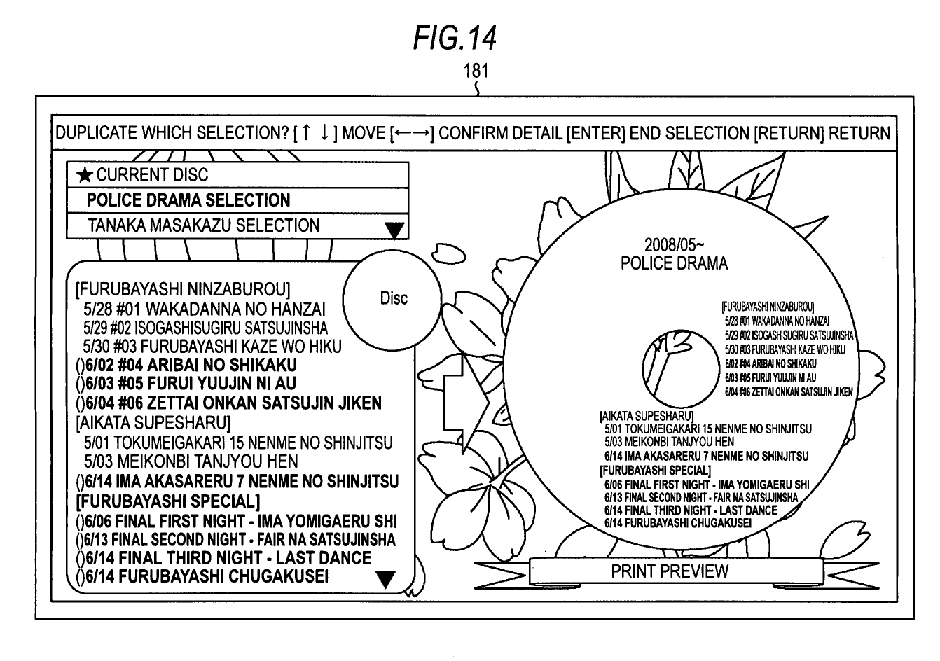

FIG. 14 is another display example of the duplication subject selection screen transitioned from the UI screen 171 shown in FIG. 13. A duplication subject selection screen 181 shows, in addition to the information of the contents recorded in the disc medium 40, information of the contents of the duplication subject candidates in highlight. Also, the print preview of the label surface of the disc medium 40 shows, in addition to the current print state, information of the contents of the duplication subject candidates in highlight.

Further, on the duplication subject selection screen 181, the user can change the groups (POLICE DRAMA SELECTION, TANAKA MASAKAZU SELECTION, SPECIAL DRAMA SELECTION, and so forth) presented as the duplication subject candidates.

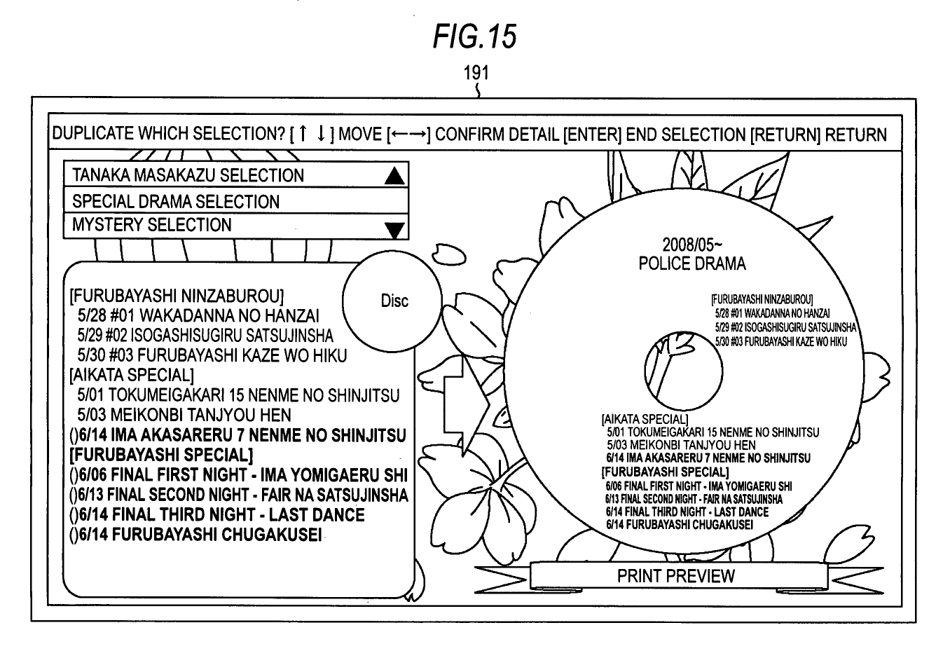

For example, on the duplication subject selection screen 181 in FIG. 14, in response to the selection of POLICE DRAMA SELECTION, three contents under the title, FURUBAYASHI NINZABUROU, belonging to the police drama, one contents under the title, AIKATA SPECIAL, belonging to the police drama, and four contents under the title, FURUBAYASHI SPECIAL, belonging to the police drama are presented as the duplication subject candidates. In a case where the user changes the groups presented as the duplication subject candidates to the special drama selection from this state, the screen display transitions to a duplication subject selection screen 191 shown in FIG. 15. That is, one contents under the title, AIKATA SPECIAL, belonging to the special drama and four contents under the title, FURUBAYASHI SPECIAL, belonging to the special drama are presented as the duplication subject candidates.

### Brief

As has been described, according to the video recorder 10 to which the present invention is applied, in a case where the loaded disc medium 40 is a blank disc, it becomes possible to duplicate the relevant contents collectively and further to print the titles of the duplicated contents on the label surface.

In a case where the loaded disc medium 40 is not a blank disc, it becomes possible to duplicate contents relevant to the already recorded contents collectively and further to additionally print the titles of the additionally duplicated contents on the label surface.

Hence, according to the video recorder 10, it becomes possible to prevent an event that various contents having no relevance to one another are mixed in a single disc medium 40. Conversely, it is also possible to prevent relevant contents from being scattered and duplicated on a plurality of disc media 40.

Further, according to the video recorder 10, the titles and the like of the duplicated contents are printed on the label surface of the disc medium 40. The user therefore becomes able to understand the recorded contents at a glance without having to play the disc medium 40 by the player.

It should be appreciated that, besides the titles of the contents, for example, thumbnail images generated from the contents, may be printed on the label surface of the disc medium 40.

The above has described a case where duplication is made from the HDD to a disc medium. However, a recording medium as the duplication source is not limited to the HDD. Also, a recording medium as a duplication destination is not limited to a disc medium as long as the medium has a printable label surface.

Besides the video recorder described above, the present invention is applicable to an electronic device having a capability of copying contents from one recording medium to another, for example, a TV set, a personal computer, a PDA, a mobile phone, a digital camera, a digital video camera, a printer, and a multi-functional printer.

The term, “system”, referred to in the present specification means an overall apparatus formed of a plurality of devices.

It should be appreciated that the present invention is not limited to the embodiment described above and the present invention can be modified in various manners without deviating from the scope of the invention.

The present application contains subject matter related to that disclosed in Japanese Priority Patent Application JP 2009-036714 filed in the Japan Patent Office on Feb. 19, 2009, the entire contents of which is hereby incorporated by reference.

What is claimed is:

1. A recording device that duplicates contents recorded in a first recording medium on a detachable second recording medium comprising:
selection means for selecting duplication subject contents to be duplicated on the second recording medium among the contents recorded in the first recording medium;
duplicating means for duplicating the selected duplication subject contents on the second recording medium;
generation means for generating label surface information that indicates contents recorded in the second recording medium after the duplication subject contents are duplicated thereon and is to be printed on a label surface of the second recording medium; and
print control means for causing the generated label surface information to be printed on the label surface of the second recording medium.

2. The recording device according to claim 1,
wherein the selection means selects contents relevant to contents already recorded in the second recording medium among the contents recorded in the first recording medium as the duplication subject contents to be duplicated on the second recording medium.

3. The recording device according to claim 2, further comprising:
obtaining means for obtaining the label surface information recorded in the second recording medium,
wherein the generation means updates the label surface information correspondingly to a state where the duplication subject contents are duplicated on the second recording medium, and
the print control means causes additional print to be made on the label surface of the second recording medium on the basis of the updated label surface information.

4. The recording device according to claim 2,
wherein the selection means presents to a user candidates of a duplication subject to be duplicated on the second recording medium among the contents recorded in the first recording medium and selects contents selected among the candidates of the duplication subject by the user as the duplication subject contents.

5. The recording device according to claim 2, further comprising:
print means for making print on the label surface of the second recording medium,
wherein the print control means controls the control means to print the generated label surface information on the label surface of the second recording medium.

6. A recording method of a recording device that duplicates contents recorded in a first recording medium on a detachable second recording medium comprising the steps, by the recording device, of:
selecting duplication subject contents to be duplicated on the second recording medium among the contents recorded in the first recording medium;
duplicating the selected duplication subject contents on the second recording medium;
generating label surface information that indicates contents recorded in the second recording medium after the duplication subject contents are duplicated thereon and is to be printed on a label surface of the second recording medium; and
causing the generated label surface information to be printed on the label surface of the second recording medium.

7. A control program of a recording device that duplicates contents recorded in a first recording medium on a detachable second recording medium causing a computer in the recording device to perform processing comprising the steps of:
selecting duplication subject contents to be duplicated on the second recording medium among the contents recorded in the first recording medium;
duplicating the selected duplication subject contents on the second recording medium;
generating label surface information that indicates contents recorded in the second recording medium after the duplication subject contents are duplicated thereon and is to be printed on a label surface of the second recording medium; and
causing the generated label surface information to be printed on the label surface of the second recording medium.

8. A recording device that duplicates contents recorded in a first recording medium on a detachable second recording medium comprising:
a selection unit configured to select duplication subject contents to be duplicated on the second recording medium among the contents recorded in the first recording medium;
a duplicating unit configured to duplicate the selected duplication subject contents on the second recording medium;
a generation unit configured to generate label surface information that indicates contents recorded in the second recording medium after the duplication subject contents are duplicated thereon and is to be printed on a label surface of the second recording medium; and
a print control unit configured to cause the generated label surface information to be printed on the label surface of the second recording medium.
